(19) United States
(12) Patent Application Publication
(10) Pub. No.: US 2011/0176383 A1
(43) Pub. Date: Jul. 21, 2011

(54) METHOD AND APPARATUS FOR ACCURATE PLACEMENT OF OCEAN BOTTOM SEISMIC INSTRUMENTATION

(75) Inventor: Stephen W. Jewell, Alvin, TX (US)

(73) Assignee: FAIRFIELD INDUSTRIES INCORPORATED, Sugar Land, TX (US)

(21) Appl. No.: 12/689,965

(22) Filed: Jan. 19, 2010

(51) Int. Cl. G01V 1/38; F16L 1/12

(52) U.S. Cl. 367/16; 367/20; 405/166

(57) ABSTRACT

Embodiments described herein relate to an apparatus and method for deployment and retrieval of one or more seismic devices in a deep water marine environment. In one embodiment, a method for deploying and positioning ocean bottom equipment is described. The method includes attaching at least one article having a negative buoyancy to a support cable, lowering the at least one article into the water column from two or more points of suspension on a surface of the water column, at least one of the two or more points of suspension being movable relative to the other point of suspension, and manipulating tension of the support cable, length of the support cable, position of the support cable, and distance between the two or more points of suspension to cause the at least one article to fall to a bottom of the water column at a predetermined location on the bottom.

### BACKGROUND OF THE INVENTION

1. Field of the Invention

The present invention relates generally to the field of marine seismic data acquisition, in particular to ocean bottom seismic (OBS) recording.

2. Description of the Related Art

Oil and gas exploration and production professionals rely heavily on seismic data in their decision making. Seismic data is collected by introducing energy into the earths surface (known as shooting or a shot), recording the subsequent reflected, refracted and mode converted energy by a receiver, and processing these data to create images of the structures beneath the surface. Imaging the earth in this manner is mathematically complex and requires accurate information regarding the source and receiver locations that produced these data.

Both two-dimensional (2D) and three-dimensional (3D) seismic surveys are carefully preplanned. The planned locations for each shot and each receiver is calculated so as to achieve the geophysical objectives of the survey, and the operations personnel attempt to follow the plan as accurately as possible. Some conventional methods used to accurately position receivers in marine environments create numerous challenges. Accurate placement of receivers has become particularly important with the advent of four-dimensional (4D) data collection wherein a 3D survey is subsequently repeated as precisely as possible in order to observe changes in the oil field itself as it is in the process of being depleted.

Streamer systems and ocean bottom cabling (OBC) systems have been utilized to collect seismic data in marine environments. However, these conventional systems suffer from numerous challenges that affect accuracy in data acquisition and/or costs associated with the survey. For example, streamer systems towed near the surface are deflected by surface currents. With streamer data, the recording device in the cable is a pressure phones and record only the reflected pressure wave because other types of particle motion are not transmitted in fluids. Ocean bottom cabling (OBC) systems have some advantages over streamer collected data. The data is recorded in the cable and transmitted to a dynamically positioned (DP) surface ship, which powers the cable and records the data, or to a surface buoy which transmits the data via radio to the nearby recording vessel using a telemetry system. By placing receivers on the ocean bottom it is possible to record primary wave (“p wave”) energy, shear waves in multiple directions, as well as pressure waves. However, OBC and telemetry systems must carry data to the surface by wire or fiber and rough sea states can create noise problems, equipment malfunction and breakage. Very deep water adds to these challenges as electrical connections under extreme hydrostatic pressure have a propensity to leak, which may interfere with signal and power transmission. For these reason OBS systems are typically limited to surveys in less than 100 meters of water.

A relatively new category of an ocean bottom recording device is the seafloor seismic recorder (SSR), sometimes referred to as a seismic node or pod. The SSR units are self contained seismic recording devices principally characterized as requiring no external wiring for activation, power, or data transmission while in operation. The SSR units are generally powered internally with rechargeable batteries and record data continuously after deployment. The SSR units are placed on the seafloor to record seismic data autonomously and are subsequently retrieved, where the recorded data is recovered for processing and permanent storage. However, conventional deployment methods of the SSR devices do not always result in accurate placement of the SSR devices on the seafloor. In an effort to increase the placement accuracy, remotely operated vehicles (ROV's) are used to deploy and retrieve the seismic devices in such surveys. However, the use of ROV's is expensive and time consuming.

Therefore, there exists a need for an apparatus and method that simplifies handling, lowers costs, and ensures accurate positioning and repeatable positioning of seismic devices on the seafloor in deep water applications.

### SUMMARY OF THE INVENTION

Embodiments described herein relate to an apparatus and method for deploying, positioning, recovering and/or relocating ocean bottom equipment, such as seismic devices. In one embodiment, a method for deploying and positioning ocean bottom equipment is described. The method includes attaching at least one article having a negative buoyancy to a support cable disposed between two or more points of suspension on or near a surface of a water column, at least one of the two or more points of suspension being movable relative to another point of suspension, lowering the at least one article into the water column, positioning the at least article above a predetermined location on a bottom of the water column, and further lowering the support cable to cause the at least one article to rest at the predetermined location.

In another embodiment, a method for deploying a plurality of seismic devices is described. The method includes providing at least a first support craft and a second support craft operating from or above a surface of a body of water, and deploying at least one cable that is suspended in an arc between the first support craft and the second support craft, the at least one cable having a plurality of seismic devices disposed thereon at predetermined intervals.

In another embodiment, a method for deploying a plurality of seismic devices in a water column is described. The method includes providing at least a first support craft and a second support craft operating from or above a surface of the water column, deploying at least one cable that is suspended in an arc in the water column between the first support craft and the second support craft, the at least one cable having a plurality of seismic devices disposed thereon at predetermined intervals and manipulating the at least one cable to cause at least one of the plurality of seismic devices to rest at a predetermined location on a bottom of the water column.

In another embodiment, a system for deploying and positioning ocean bottom equipment is described. The system includes at least a first support craft and a second support craft operating from or above a surface of a water column, at least one cable disposed between the first support craft and the second support craft, the at least one cable having one or more seismic devices disposed thereon at predetermined intervals, and one or more locational sensors disposed on the one or more seismic devices or the cable.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of one embodiment of a seismic device deployment operation in a body of water.

FIGS. 2A-2E are schematic views of another embodiment of a deployment method into a body of water.

FIGS. 2F-2J are schematic views of one embodiment of a positioning method.

FIGS. 3A-3C illustrate top plan views of embodiments of adjustments performed by one or both of the first and second support crafts of FIGS. 2A-2J.

FIGS. 4A-4F are schematic views of one embodiment of a mainline cable relocation process.

FIG. 5 is a plan view of one embodiment of a three-dimensional (3D) seismic apparatus adapted as a web.

FIG. 6 is an isometric view of a positioning method for the web of FIG. 5.

FIGS. 7A and 7B are schematic views of another embodiment of a seismic device deployment operation.

FIG. 8 is a schematic view of another embodiment of a seismic device deployment operation.

FIG. 9 is a flow chart showing one embodiment of a seismic device deployment method.

To facilitate understanding, identical reference numerals have been used, where possible, to designate identical elements that are common to the figures. It is also contemplated that elements disclosed in one embodiment may be beneficially utilized on other embodiments without specific recitation.

### DETAILED DESCRIPTION

Embodiments described herein relate to an apparatus and method for transferring one or more seismic devices to or from a support craft on or near a surface of a body of water and a subsurface marine location. Seismic devices as used herein include but are not limited to seismic sensor devices whether cabled or autonomous, navigation and location instrumentation, buoyancy devices, whether positively or negatively buoyant, retrieval support mechanisms, deployment or retrieval machinery and similar devices. Each of the seismic sensor devices as described herein may be a discrete subsurface sensor, for example, sensors and/or recorders, such as ocean bottom seismometers (OBS), seafloor seismic recorders (SSR), and similar devices. SSR's are typically re-usable and may be recharged and serviced before re-deployment. The seismic sensor devices may be configured to communicate by wireless connections or configured to communicate through cables. The seismic sensor devices contain seismic sensors and electronics in sealed packages, and record seismic data within an on-board recorder while deployed on the seafloor as opposed to digitizing and transmitting the data to an external recorder. The recorded data is obtained by retrieving the seismic sensor devices from the seafloor. The apparatus and method as described herein is configured to be utilized in deep water with depths of 500 meters or greater. However, similar procedures could be used in shallower bodies of water with lesser numbers or mass of devices, increased mainline cable strengths and/or increased vessel bollard pull. The support craft may be a marine vessel, such as a boat, a ship, a barge or a floating platform adapted to store and transfer a plurality of seismic devices. In some embodiments, the support craft may be a helicopter.

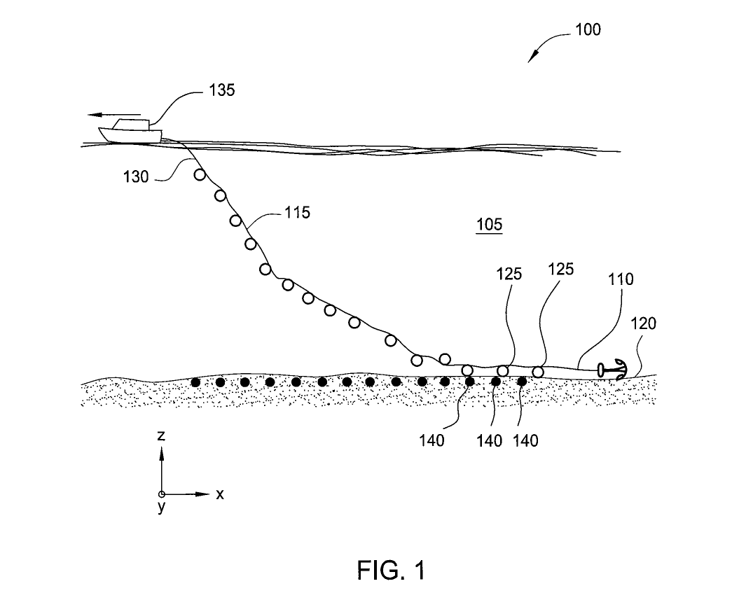

FIG. 1 is a schematic view of one embodiment of a seismic deployment operation 100 in a body of water 105. The deployment operation 100 comprises deploying a free end 110 of a flexible cable 115 relative to a seafloor 120. The free end is often terminated with some negative buoyancy device such as an anchor. The flexible cable 115 includes a plurality of discrete seismic devices 125 that are coupled to the flexible cable 115 at predetermined locations. In one embodiment, each of the seismic devices 125 comprise seismic sensor devices, such as SSR's. A second end 130 of the flexible cable 115 is coupled to a support craft 135, which in one embodiment is a marine vessel, such as a boat or ship. As the support craft 135 moves, the flexible cable 115 having the seismic devices 125 thereon is paid out and allowed to fall through the body of water 105 and rest on the seafloor 120. After the seismic devices 125 are deployed and resting on the seafloor 120, a seismic survey may be initiated by inducing source energy (i.e., acoustic energy or a shot) into the body of water 105.

The support craft 135 includes cable handling equipment and storage capacity for additional seismic devices. In one mode of deployment, the seismic devices 125 and the flexible cable 115 are stored on the support craft 135 when the seismic devices 125 are not in use. During deployment, individual seismic devices 125 are attached to the flexible cable 115 as the flexible cable 115 is paid out. After the seismic survey is completed, the flexible cable 115 is retrieved and coupled to the support craft 135, and the flexible cable 115 is winched in. During the retrieval of the flexible cable 115, personnel on the support craft 135 detach the seismic devices 125 from the flexible cable 115. The flexible cable 115 and seismic devices 125 are stored for transport and/or servicing.

The locations for each shot and each seismic device 125 are carefully preplanned and operations personnel attempt to follow the plan as accurately as possible. The location of seismic devices 125 along flexible cable 115 is modeled to allow the seismic devices 125 to rest at intended locations 140 on the seafloor 120. However, many factors affect the final resting position of the seismic devices 125 such that the seismic devices 125 may not come to rest sufficiently close to their intended locations 140. For many purposes this deployment method has been successfully used because computational methods exist to accurately determine the final resting position of the seismic devices 125 on the seafloor 120. For example, the final resting position of each of the seismic devices 125 may be determined after-the-fact from the recorded seismic data itself.

The deployment method 100 is successfully utilized to obtain two-dimensional (2D) and three-dimensional (3D) data as the final resting position of each seismic device 125 is computationally determined. Thus, slight positional deviations from the intended locational positions 140 may be tolerated. However, for purposes such as four-dimensional (4D) seismic studies, wherein the deployment method 100 must be duplicated, the resultant deviations from preplanned locations make the deployment mechanism unsuitable. For example, while the final resting place of the seismic devices 125 is known thru computational methods in 2D or 3D surveys, the deployment method 100 is not capable of repeating a second or subsequent 2D or 3D surveys with required accuracy.

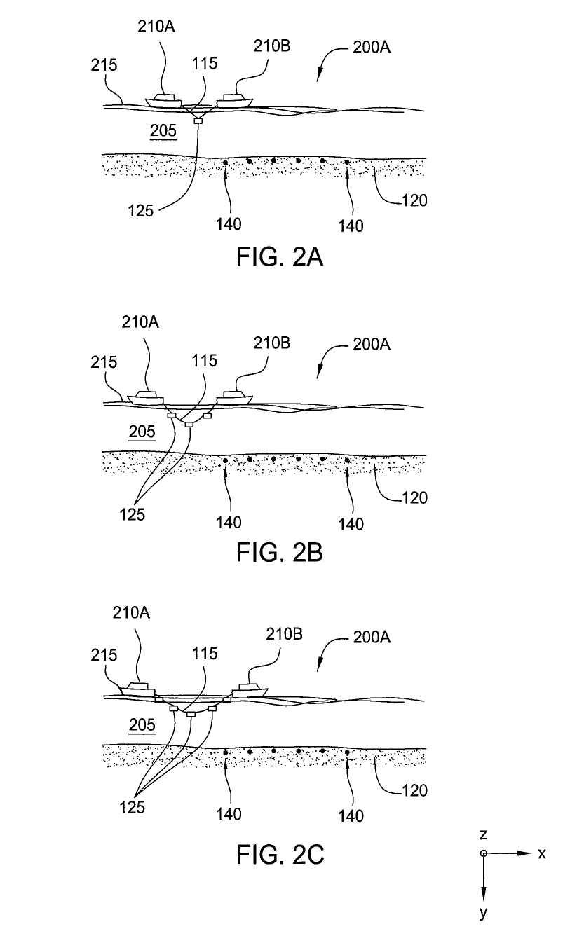

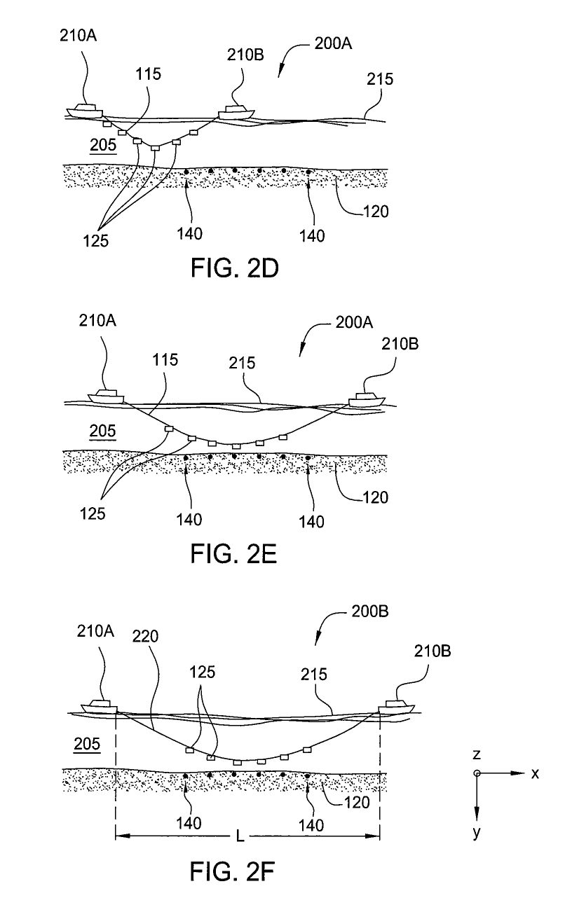

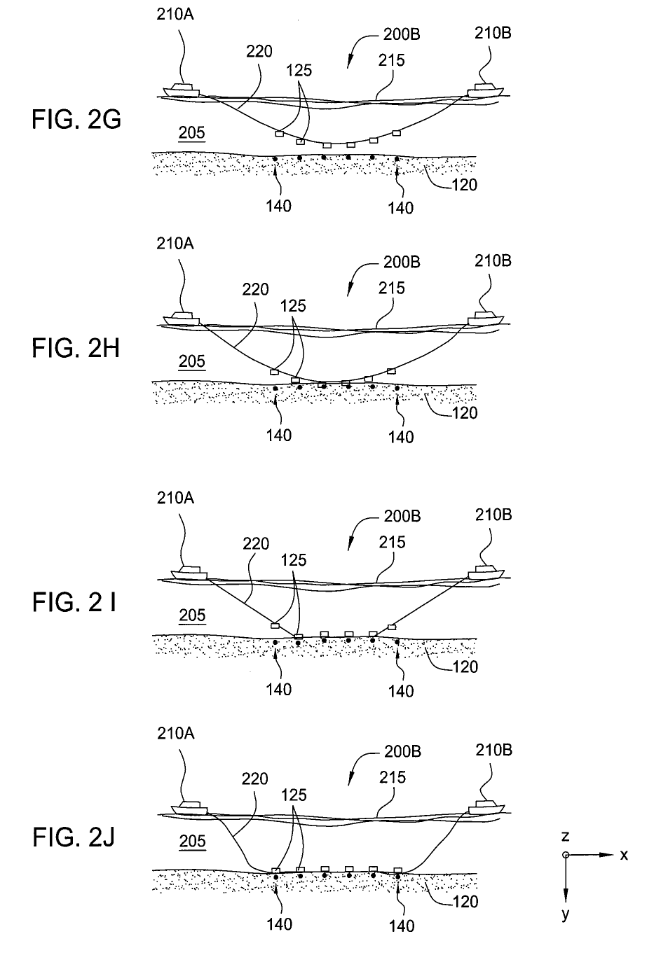

FIGS. 2A-2E are schematic views of another embodiment of a deployment method 200A into a body of water or water column 205. In this embodiment, a flexible cable 115 having at least one article having a negative buoyancy, such as one or more seismic devices 125 attached thereto, is extended between two points of suspension. In one embodiment, each of the seismic devices 125 comprise seismic sensor devices, such as SSR's. In this embodiment, the two points of suspension comprise support crafts, such as a first support craft 210A and a second support craft 210B operating from a surface 215 of the water column 205. The flexible cable 115 having the seismic devices 125 thereon is controllably deployed into the water column 205. The flexible cable 115 may be deployed over distances from as little as a few hundred meters to many kilometers which may have affixed many hundreds of the seismic devices 125 disposed thereon to define a mainline cable.

In this embodiment, tensioning of the flexible cable 115 is controlled by both of the first and second support crafts 210A, 2108. In one embodiment, at least one of the support crafts 210A, 210B is a marine vessel, such as a boat or ship. In another embodiment, each of the first and second support crafts 210A, 210B are powered marine vessels with the capability of managing opposing ends of the flexible cable 115, and/or applying varied forces to the flexible cable 115. In this embodiment, one or both of the first and second support crafts 210A, 210B may operate to pay out the flexible cable 115 and facilitate attachment of the seismic devices 125 thereon as the flexible cable 115 is being paid out. Alternatively, only one of the first and second support crafts 210A, 210B may have the ability to adjust handling parameters of the flexible cable 115 and/or facilitate attachment of seismic devices 125. For example, the first support craft 210A may be a floating platform, a barge or a buoy that is anchored or fixed relative to the second support craft 210B. In this example, the majority of the deployment parameters, such as cable pay out and/or attachment of seismic devices 125, may be managed entirely by the second support craft 210B with the first support craft 210A providing only tension to the flexible cable 115. In another alternative, the first support craft 210A may be a barge or a buoy that includes a winch or other tensioning device coupled to the flexible cable 115.

FIGS. 2F-2J are schematic views of one embodiment of a positioning method 200B. Collectively, the flexible cable 115 and the plurality of seismic devices 125 define a mainline cable 220. The mainline cable 220 is suspended in the water column 205 between the first and second vessels 210A, 210B in a predictable, generally curved shape. For example, if seismic devices 125 of uniform mass were uniformly distributed along the cable the shape would approximate a catenary curve or arc. However, the shape of the suspended mainline cable 220 can be altered by redistributing the suspended masses on the cable 115, such as the number and/or size of the seismic devices 125. Alternatively or additionally, the cable 115 may include positive or negative buoyancy devices that redistributes weight on the cable 115. The cable 115 may be a wire or rope. The cable 115 may comprise a single length or multiple lengths that are coupled at respective ends. The cable 710 may include conductors, such as wires or fiber optics adapted to transmit signals between the support crafts 210A and/or 210B. Additionally, the cable 115 may include attached or integral positional sensing devices.

As the mainline cable 220 is suspended between the first and second support crafts 210A, 210B, the mainline cable 220 may be positioned above the intended locational positions 140. The high tension along the length of the mainline cable 220 provides great stability in the tangential direction (X direction) and is thus highly resistant to forces in the water column 205 that might otherwise displace the mainline cable 220 in that direction (X direction). The mainline cable 220 is still subject to displacement in the orthogonal direction (Y direction). However, as is known in the art, currents are predominantly near surface phenomena and these currents are generally slight below 500 meters. As the majority of the mainline cable 220 and the bulk of affixed devices are below 500 meters, the majority of the mainline cable 220 is not subject to these currents. Thus, fine adjustments of the mainline cable 220 by one or both of the first and second support crafts 210A, 210B may be performed to accurately position the seismic devices 125 above the intended locational positions 140 on the seafloor 120.

FIGS. 2G-2J show the mainline cable 220 being controllably lowered to place the seismic devices 125 at the intended locational positions 140. The mainline cable 220 may be lowered by paying out additional lengths of the flexible cable 115 from one or both of the first and second support crafts 210A, 210B. It is noted that during the lowering of the mainline cable 220, adjustment of the mainline cable 220 may be made in the X direction without further adjustment of vessel positions. For example, in one embodiment the first and second support crafts 210A, 210B have assumed predetermined X locations on the surface and any final necessary X directional adjustments may be performed by paying out additional cable from one support craft which may be taken up by the other support craft.

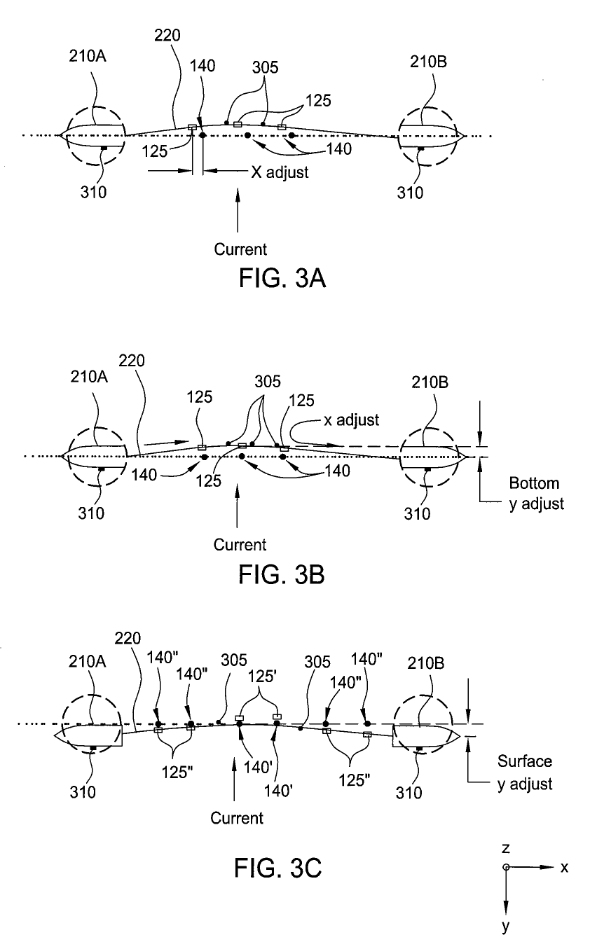

FIGS. 3A-3C illustrate top plan views of embodiments of adjustments to correct for orthogonal (Y direction) misplacement performed by one or both of the first and second support crafts 210A, 210B prior to or in conjunction with lowering of the mainline cable 220. In these figures, the mainline cable 220 is affected by an exemplary current that is flowing generally in a normal direction (Y direction) relative to the length of the mainline cable 220. In this embodiment, one or more positional sensors 305 are coupled to the mainline cable 220 at various locations along the length of the mainline cable 220 to facilitate positioning of the mainline cable 220 relative to the intended locational positions 140. The one or more positional sensors 305 may be acoustic transponders, inertial or Doppler navigation devices, or other device located in or on the mainline cable 220. Each of the positional sensors 305 are adapted to transmit locational information to one or both of the first and second support crafts 210A, 210B or to another surface support craft (not shown) not otherwise involved in the mainline cable 220 suspension or positioning. In this embodiment, each of the support crafts 210A, 210B include a transponder 310, such as an acoustic receiver. Each of the transponders 310 are adapted to communicate with the sensors 305. The one or more sensors 305 provide a locational metric of the mainline cable 220 relative to the intended locational positions 140. Thus, adjustments of the mainline cable 220 in the X and/or Y directions may be made based on real time locational data provided by the one or more sensors 305.

FIG. 3A indicates adjustments of the mainline cable 220 in the X direction. Data from the one or more sensors 305 may be used to indicate a positional error of the mainline cable 220 relative to the intended locational positions 140. X directional adjustment of the mainline cable 220 may be performed by movement of one or both of the first and second support crafts 210A, 210B in the X direction. Additionally or alternatively, adjustments in the X direction may be performed by paying out or taking up the mainline cable 220 by one or both of the first and second support crafts 210A, 210B.

FIGS. 3B and 3C indicate completed adjustment of the mainline cable 220 in the X direction wherein Y direction corrections are needed. Y adjustments of the mainline cable 220 are performed by offsetting one or both of the first and second support crafts 210A, 210B to account for the measured error derived from the one or more sensors 305. The corrections in the Y direction necessary on the surface will usually be of larger magnitude to effect any measured bottom Y direction positional error and may be continuously altered and updated as the mainline cable 220 is lowered and seismic devices 125 nearer and nearer to the support craft are landed on the bottom at their intended locational positions 140. For example, in FIG. 3C, one or more central seismic devices 125′ are positioned accurately and landed at one or more central intended locational positions 140′. In this position, the one or more central seismic devices 125′ may be effectively utilized as an anchor to facilitate positioning and placement of outward seismic devices 125″ at outward intended positional locations 140″. In one embodiment, one or more central seismic devices 125′ are landed first and each successive seismic device, such as outward seismic devices 125″, are landed successively in a center-first/end-last or center to end manner.

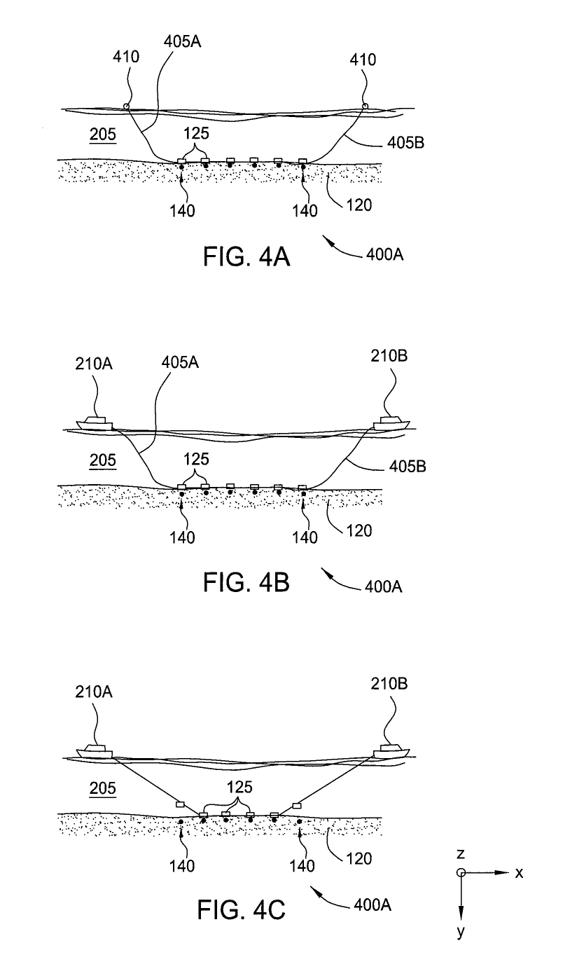

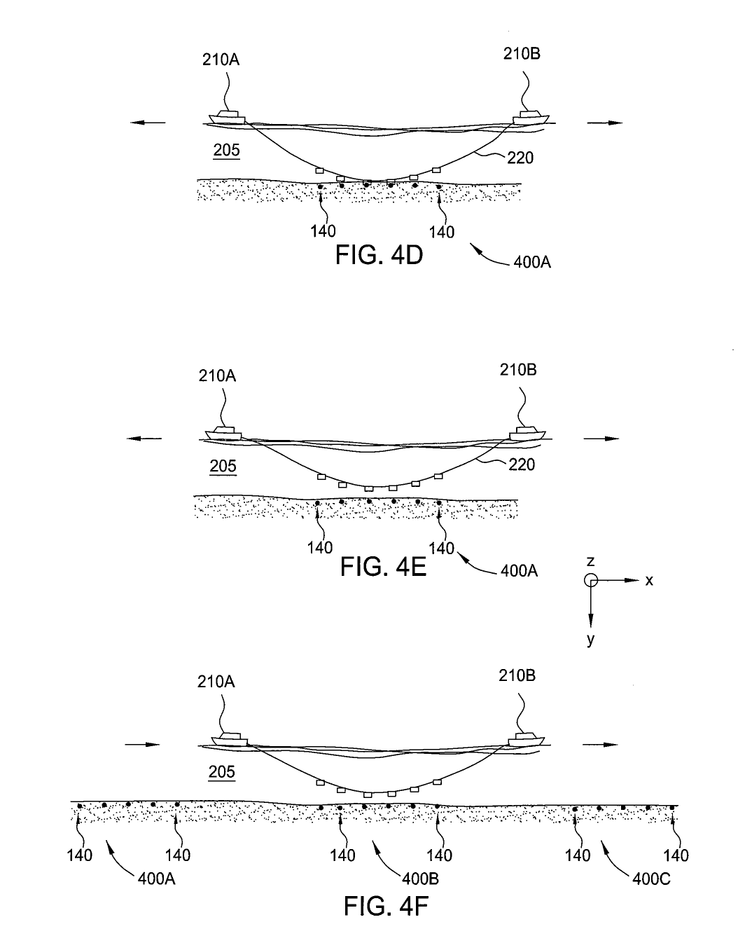

FIGS. 4A-4F are schematic views of one embodiment of a mainline cable relocation process. In this series of Figures, the mainline cable 220 forms a first seismic array 400A on the seafloor 120 as defined by the intended locational positions 140. The mainline cable 220 may be lifted clear of the seafloor 120 and moved to another location to form a second array without the need to retrieve and redeploy the mainline cable 220. As used herein, retrieval refers to recovering the mainline cable 220 and the affixed seismic devices 125 by reeling in the cable 220 onto one or both the support craft 210A and 210B and removing the seismic devices 125 from the cable 220. After the cable 220 has been recovered and the seismic devices 125 are removed, the support crafts 210A and 210B may move to another location and redeploy the cable 220 as described in FIGS. 2A-2E. By contrast, relocation refers to moving the cable 220 with seismic devices 125 affixed thereon to a new location without need for retrieval of the cable 220. The relocation process saves multiple man-hours and minimizes equipment handling as opposed to retrieval and re-deployment. Thus, cost of the seismic survey is minimized due to the reduced vessel time and the minimization of equipment handling and potential damage.

FIG. 4A is a schematic view of an unattended mainline cable 220 having the plurality of seismic devices 125 positioned accurately at the intended locational positions 140 as described in FIGS. 2F-3C. In this position, source energy may be introduced and seismic data may be collected by the plurality of seismic devices 125. After that seismic data has been collected, the mainline cable 220 may be lifted and relocated without retrieval.

In one embodiment, the mainline cable 220 includes a first end 405A and a second end 405B that are coupled with the first and second support crafts 210A, 210B during deployment. After deployment, the first end 405A and the second end 405B made retrievable by means of buoyancy device 410. Buoyancy devices 410 are well know to those skilled in the art and may float freely on the surface or maintained below the surface and released for surface retrieval by a selectively actuated acoustic signal. Once actuated, the buoyancy device 410 rises to the surface of the water column where personnel on the first and second support crafts 210A, 210B may retrieve the first and second ends 405A, 405B of the mainline cable 220 and secure the ends to the retrieval machinery aboard the first and second support crafts 210A, 210B.

FIG. 4B shows the first and second support crafts 210A, 210B having the first end 405A and the second end 405B of the mainline cable 220 retrieved and coupled to the respective vessel. FIGS. 4C-4D show the first and second support crafts 210A, 210B tensioning the mainline cable 220 in a manner that raises the plurality of seismic devices 125 from the seafloor 120. Tensioning of the mainline cable 220 is accomplished by one or a combination of movement of the first support craft 210A and/or second support craft 210B in the X direction as well as tensioning from tensioning devices, such as winch devices located on one or both of the first and second support crafts 210A, 210B.

FIG. 4E shows the mainline cable 220 under tension between the first and second support crafts 210A, 210B and all of the seismic devices 125 are lifted clear of the seafloor 120. Once the seismic devices 125 are clear of the seafloor 120 and the mainline cable 220 is suspended, the mainline cable 220 may be moved to another location by the support crafts 210A, 210B.

FIG. 4F shows the first and second support crafts 210A, 210B maintaining tension in the mainline cable 220 and moving synchronously to a new position. In this embodiment, the mainline cable 220 is retrieved from the first plurality of intended locational positions 140 in the first array 400A and is being transferred to a position above a second plurality of intended locational positions 140 defining a second array 400B. The mainline cable 220 may be positioned and lowered onto the second plurality of intended locational positions 140 as described in FIGS. 2F-3C. After positioning, the mainline cable 220 may be released and the seismic survey continued using the second array 400B. After the seismic data is collected at the second array 400B, the mainline cable 220 may once again be captured and relocated as described in FIGS. 4A-4E to a third plurality of intended locational positions 140 defining a third array 400C. While the second array 400B and third array 400B is shown in the X direction relative to the first array 400A, the second array 400B and third array 400B may by located in the Y direction relative to the first array 400A. Thus, the relocation method may be configured linearly by relocating the mainline cable 220 in the X direction, configured laterally by relocating the mainline cable 220 in the Y direction in a side-by-side or parallel relationship, or combinations thereof.

As needed, the mainline cable 220 may be retrieved by one or both of the first and second support crafts 210A, 210B. The seismic devices 125 may be detached from the flexible cable and stored or readied for another deployment. In another embodiment, the seismic devices may be powered from the surface and transmit data to the surface via conductors contained within the mainline cable 220 or other means. In this embodiment, many relocation procedures may be permitted without the need for retrieval of the seismic devices 125. In some cases the entire seismic survey might be completed with single initial deployment and a single final retrieval with many intervening relocations of the mainline cable 220.

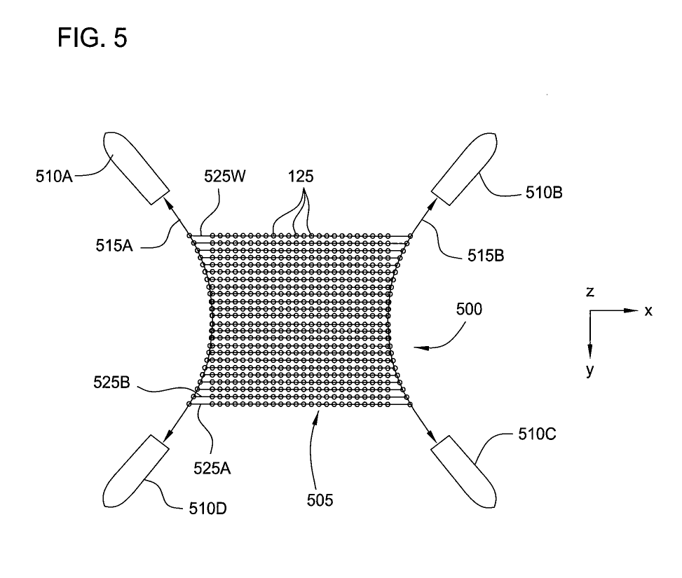

FIG. 5 is a plan view of one embodiment of 3D seismic device adapted as a receiver web 500. The receiver web 500 includes a plurality of flexible cables having a plurality of seismic devices 125 attached thereto to form a plurality of mainline cables 525A-525W. In this embodiment, the receiver web 500 is rectangular and is suspended by four points of suspension. In one embodiment, each of the points of suspension comprise support crafts, such as a first support craft 510A, a second support craft 510B, a third support craft 510C and a fourth support craft 510D. One or more of the support crafts 510A-510D may be marine vessels, helicopters, a floating vessel, such as a barge or buoy that is anchored. In one embodiment, the support crafts 510A-510D are vessels that are utilized in a seismic survey operation. For example, the first and second support crafts 510A, 510B may be gun boats, the third support craft 510C may be a service boat, and the fourth support craft 510D may be a seismic device or node handling boat. The receiver web 500 is coupled to two support lines 515A, 515B at opposing sides of the receiver web 500. Each of the support lines 515A, 515B have respective ends that are coupled to the support crafts 510A-510D.

While not shown, other embodiments of the receiver web may be utilized using more or less than four points of suspension. For example, the receiver web 500 may be suspended by three support crafts at three points of suspension. In addition, the receiver web may be in a different shape, such as triangular.

The receiver web 500 may be an integrated unit that is carried by one of the plurality of support crafts 510A-510D in a folded or rolled-up condition and unfolded or un-rolled in deep water near the area of interest. For example, each of the support lines 515A, 515B on the receiver web 500 may be coupled to the support crafts 510A-510D and opened by each of the support crafts 510A-510D pulling in opposing directions. Alternatively, the receiver web 500 may be formed at or near the area of interest. For example, flexible cable and seismic devices 125 may be transported to the deep water location by one or more of the support crafts 510A-510D. The flexible cable may be paid out between two of the support crafts 510A-510D and seismic devices 125 are attached thereto as the cable is being paid out. After a mainline cable is completed, the completed mainline cable is attached to the support lines 515A, 515B, which may be temporarily coupled to a floating structure, such as an anchored barge or buoy that maintains tension in the support lines 515A, 515B and thus the completed mainline cable coupled thereto.

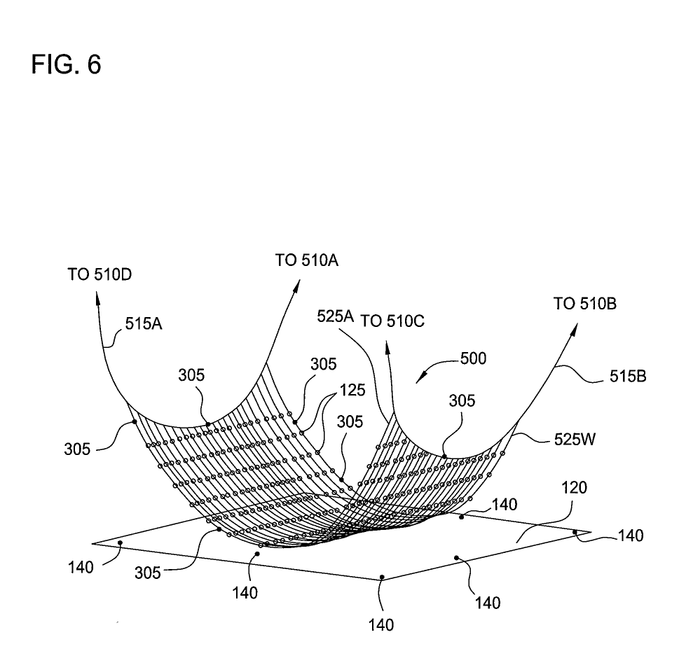

FIG. 6 is an isometric view of the receiver web 500 positioned above a seafloor 120. In this embodiment, the receiver web 600 includes 24 mainline cables 525A-525W each having 24 seismic devices 125 coupled thereto The receiver web 500 may be any suitable size limited by logistical issues of transportation and/or onsite layout and the size and/or towing capability of the support crafts 510A-510D.

The receiver web 500 can include a plurality of sensors 305 coupled to the support lines 515A, 515B and or on mainline cables 525A-525W at pre-determined locations. The plurality of sensors 305 may be used to provide positional information of the receiver web 500 relative to the intended positional locations 140 on the seafloor 120. Data from the one or more sensors 305 may be used to indicate a positional error of any one or combination of the mainline cables 525A-525W and/or the support lines 515A, 515B. Positional information from the one or more sensors 305 may be transmitted to one or all of support crafts 510A-510D and the position of the support crafts 510A-510D may be changed to correct the position of the receiver web 500, or portions thereof, relative to the intended locational positions 140.

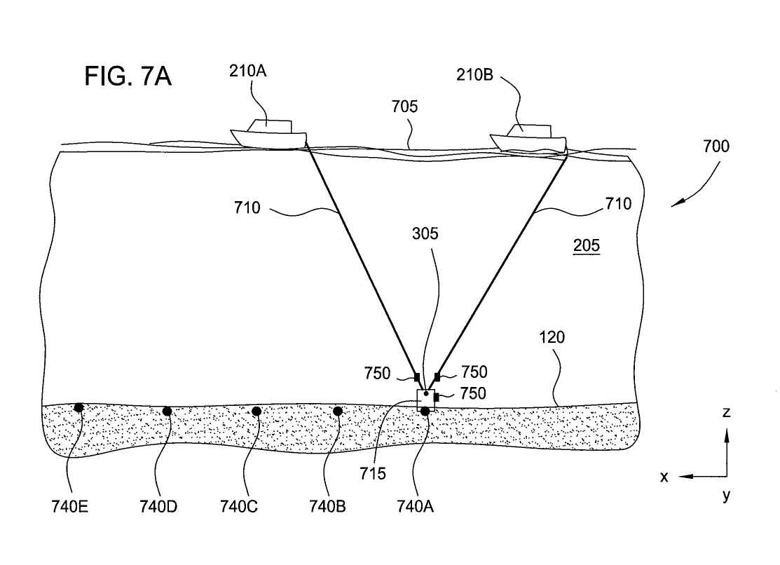

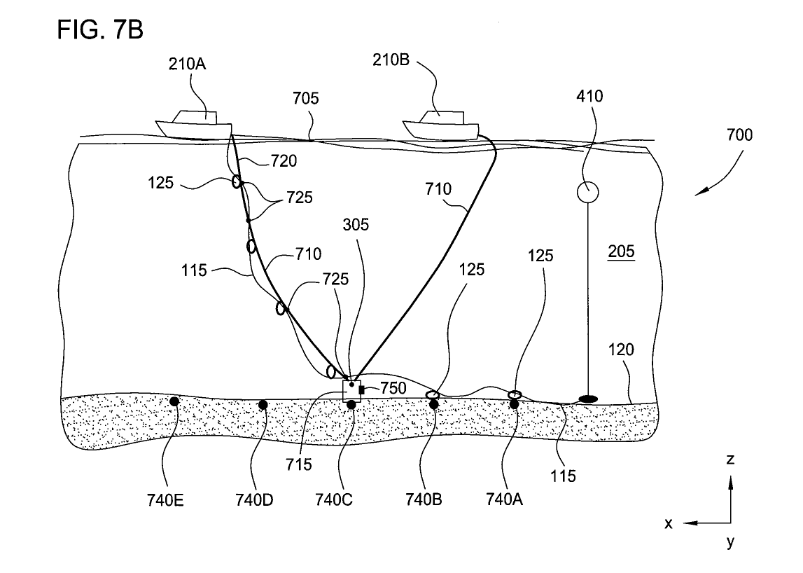

FIGS. 7A and 7B are schematic views of another embodiment of a seismic device deployment operation 700. In this embodiment, a support cable 710 is suspended between a plurality of support crafts, such as a first support craft 210A and a second support craft 210B operating on a surface 705 of the water column 205. A single article configured for deep water operations, such as a placement device 715, is coupled along the length of the support cable 710. The placement device 715 may be a weighted object that has a negative buoyancy and may be fastened to the support cable 710 or adapted to slide or move along the support cable 710. The support cable 710 may comprise a single length or multiple lengths that are coupled at respective ends. The support cable 710 may be a wire or rope or be adapted as an umbilical cable. The support cable 710 may include conductors, such as wires or fiber optics adapted to transmit signals between the support crafts 210A and/or 210B and the placement device 715.

In operation, one or both of the support crafts 210A, 210B pay out a length of the support cable 710 having the placement device 715 thereon. Each of the support crafts 210A, 210B are utilized to raise, lower and position the placement device 715 relative to the seafloor 120 by tensioning the support cable 710 and/or movement of one or both of the support crafts 210A, 210B on the surface 705 of the water column 205. The placement device 715 is positioned by the support crafts 210A, 210B to place seismic devices 125 (not shown) at the intended locational positions 140 as shown in FIG. 7B. In one embodiment, the placement device 715 includes a mass or weight that is configured to maintain tension in the support cable 710 when the placement device 715 is suspended in the water column 205. The placement device 715 includes a sensor 305 adapted to transmit a locational metric of the placement device 715 in the water column 205. The sensor 305 allows the support crafts 210A, 210B to accurately position the placement device 715 adjacent the intended locational positions 140 on the seafloor 120. In addition, one or more propulsion devices 750 may be coupled to one or both of the support cable 710 and the placement device 715. The propulsion device 750 may be a thruster that is adapted to aid in movement and positioning of the placement device 715 relative to the seafloor 120.

FIG. 7B is a schematic view of a flexible cable 115 having seismic devices 125 attached thereto being transferred down a first side 720 of the support cable 710. The flexible cable 115 may be paid out from the first support vessel 210A and the seismic devices 125 may be coupled to the flexible cable 115. The flexible cable 115 may be coupled to the support cable 710 by clamps 725. The clamps 725 are adapted to slide along the support cable 710 to guide the flexible cable 115 and seismic devices 125 toward the placement device 715. The clamps 725 are configured to release remotely by acoustic signal, or by a mechanical release mechanism integral to the placement device 715 to allow the flexible cable 115 to be released from the support cable 710. In one embodiment, the clamps 725 are adapted to release when a predetermined amount of drag is applied, such as drag produced when a seismic device or devices 125 is placed on the seafloor 120 and the placement device 715 is moved relative to the landed seismic device 125. In another embodiment, the clamps 725 are configured to release remotely, such as by acoustic signal from the placement device 715 or one or both of the support crafts 210A, 210B.

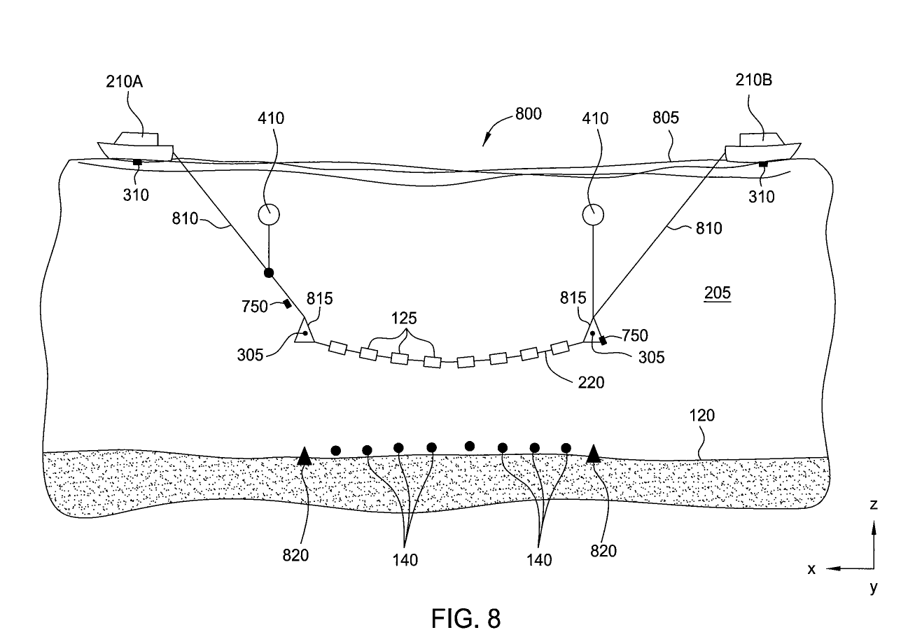

FIG. 8 is a schematic view of another embodiment of a seismic device deployment operation 800. In this embodiment, two support cables 810 are coupled to a respective support craft, such as a first support craft 210A and a second support craft 210B operating on a surface 805 of the water column 205. At least two articles configured for deep water operations, such as a placement device 815, is coupled along the length or end of the support cables 810. The placement devices 815 may be a weighted object that has a negative buoyancy and may be fastened to the support cables 810 to support a mainline cable 220 therebetween. The support cable 810 may comprise a single length or multiple lengths that are coupled at respective ends. The support cable 810 may be a wire or rope or be adapted as an umbilical cable. The support cable 810 may include conductors, such as wires or fiber optics adapted to transmit signals between the support crafts 210A and/or 210B.

In operation, one or both of the support crafts 210A, 210B tension the support cable 810 to lift, lower and position the placement devices 815. Each of the placement devices 815 are spaced and tensioned to support the mainline cable 220 in a catenary or other predictable curve. In one embodiment, the placement devices 815 include a sensor 305 adapted to transmit a locational metric of the placement devices 815 in the water column 205. The sensor 305 allows the support crafts 210A, 210B to accurately position the seismic devices 125 on the intended locational positions 140 on the seafloor 120. In this embodiment, each of the support crafts 210A, 210B include a transponder 310. Each of the transponders 310 may be an acoustic receiver, or other transmitter/receiver adapted to communicate with the sensors 305. In addition, one or more propulsion devices 750 may be coupled to one or both of the support cable 810 and or the placement device 815. The propulsion device 750 may be a thruster that is adapted to aid in movement and positioning of the placement device 815 relative to the seafloor 120.

In one embodiment, one or both of the support cable 810 and the placement devices 815 include a buoyancy device 410. In this embodiment, the placement devices 815 may be lowered to the seafloor 120 to rest at anchor locations 820 and subsequently retrieved. For example, after each of the plurality of seismic devices 125 are positioned at the respective intended locational positions 140, the placement devices 815 may be lowered to the seafloor 120 and the support cables 810 may be released from the support crafts 210A, 210B. When the mainline cable 220 is to be retrieved or relocated, the buoyancy devices 410 may be actuated to facilitate reattachment of the support cables 810 to the support crafts 210A, 210B. After reattachment of the support cables 810, the mainline cable 220 may be relocated or retrieved.

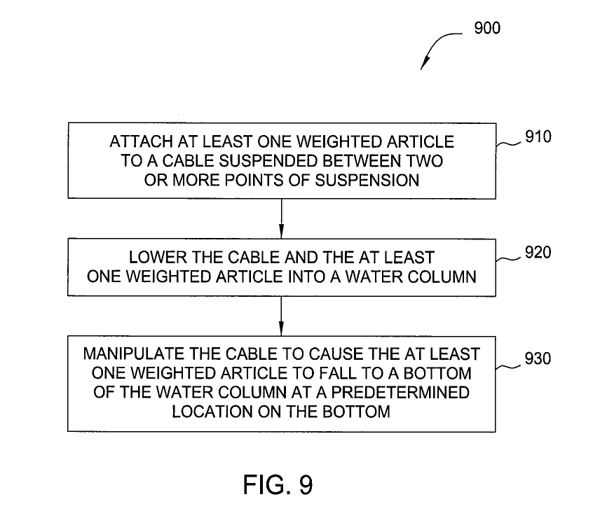

FIG. 9 is a flow chart showing one embodiment of a seismic device deployment method 900. At 910, at least one weighted article is attached to a cable. The cable may be a flexible cable 115 as described in FIGS. 2A-2J and FIGS. 4A-4F, a support cable 710 as described in FIGS. 7A and 7B, a support cable 810 as described in FIG. 8, or one or both of the support cables 515A, 515B as described in FIGS. 5 and 6. The at least one weighted article may be one or more of the plurality of seismic devices 125 as described herein, the placement device 715 as described in FIGS. 7A and 7B, or the placement devices 815 described in FIG. 8. The two or more points of suspension may be support crafts as described herein, such as a first support craft 210A and a second support craft 210B as described in FIGS. 2A-4F, FIGS. 7A and 7B and FIG. 8, as well as one or more of the support crafts 510A-510D described in FIG. 5.

At 920, the cable and the at least one weighted article is lowered into a water column 205. At 930, at least one of two or more cable ends is manipulated to cause the at least one weighted article to fall to a bottom of the water column 205 seafloor 120) at a predetermined location (i.e., intended locational positions 140) on the bottom. In one embodiment, where the at least one weighted article is one or more seismic devices 125 and all of the seismic devices 125 are positioned at the intended locational positions 140. After recording at these locations is complete, the respective ends of the cable may be retrieved and reattached to the two or more points of suspension and tensioned to raise the cable free of the bottom. The seismic devices 125 may be retrieved, removed from the cable and stored. Alternatively, the cable and the at least one weighted device may be moved to another location without necessitating recovery and redeployment.

A method and apparatus for accurate placement of ocean bottom seismic equipment is described. In one embodiment, a cable or rope with at least one deep water article, such as deep water equipment or sensors, is affixed to the cable or incorporated in the cable, and is lowered in a water column. In one aspect, the cable and/or the at least one deep water article is suspended from at or near a surface of the water column at multiple points. Between points of suspension, the cable hangs in the water column approximating a catenary or other predictable curve depending on the distribution of weight along the cable length. The cable and/or deep water equipment may be lowered to a bottom of the water column and lifted free from the bottom allowing the cable and any integral equipment located thereon to be repositioned without retrieval of the majority of the cable and/or equipment. The deep water article may include but is not limited to ocean bottom recording nodes, ocean bottom cables, acoustic transponders, ROV's, and other forms of instrumentation and machinery for ocean bottom mineral exploration and exploitation.

The accurate positioning of the deep water articles facilitates more accurate and reproducible seismic surveys when compared to conventional methods. The methods described herein prevent unintended gaps in coverage which can necessitate vessel redeployment and additional collection work often at great additional expense. The method and apparatus as described herein also reduces or eliminates the need for ROV's which are expensive to operate and maintain. Thus, the method and apparatus as described herein enables increased accuracy of seismic device placement for 2D or 3D seismic surveys and enables increased accuracy of placement of seismic devices for subsequent surveys in 4D studies. The increased accuracy minimizes or eliminates normalization computations to determine final resting positions for the seismic devices in 2D or 3D surveys, which also minimizes costs.

While the foregoing is directed to embodiments of the invention, other and further embodiments of the invention may be devised without departing from the basic scope thereof.

What is claimed is:

1. A method for deploying and positioning ocean bottom equipment, comprising:
attaching at least one article having a negative buoyancy to a support cable disposed between two or more points of suspension on or near a surface of a water column, at least one of the two or more points of suspension being movable relative to another point of suspension;
lowering the at least one article into the water column;
positioning the at least article above a predetermined location on a bottom of the water column; and
further lowering the support cable to cause the at least one article to rest at the predetermined location.

2. The method of claim 1, wherein the positioning of the at least one article comprises:
manipulating the support cable.

3. The method of claim 2, wherein manipulating the support cable comprises:
manipulating tension of the support cable, length of the support cable, position of the support cable, the locations or distance between the two or more points of suspension, and combinations thereof.

4. The method of claim 3, wherein at least a portion of the manipulation of the support cable is based on a positional metric provided by one or more devices disposed on the support cable or the at least one article.

5. The method of claim 2, wherein manipulating the support cable comprises moving at least one of the two or more points of suspension.

6. The method of claim 5, wherein the moving at least one point of suspension is based on a real-time positional metric of the support cable or the at least one article.

7. The method of claim 1 where one or more devices are disposed on the support cable or the at least one article to provide a locational metric of the support cable or the at least one article.

8. The method of claim 1, wherein the at least one article comprises a plurality of seismic devices attached to the support cable.

9. The method of claim 8, further comprising:
providing a source signal into the water column after the support cable and the plurality of seismic devices are resting on the bottom at a plurality of first intended locational positions.

10. The method of claim 9, further comprising:
lifting the plurality of seismic devices and the support cable to a position in the water column using at least one of the two or more points of suspension such that each of the plurality of seismic devices and the support cable are spaced away from the bottom.

11. The method of claim 10, further comprising:
transferring the support cable and the seismic devices to a second plurality of intended locational positions on the bottom.

12. The method of claim 1, further comprising:
transferring a plurality of seismic devices coupled to a mainline cable from one of the at least two points of suspension to the bottom along the support cable.

13. The method of claim 12, wherein the mainline cable comprises a device to provide a locational metric to one of the two or more points of suspension locational device

14. The method of claim 1, further comprising:
depositing a first seismic device at a first predetermined location on the bottom; and
manipulating the support cable to position a second seismic device above a second predetermined location on the bottom.

15. The method of claim 14, further comprising:
depositing the second seismic device at the second predetermined location on the bottom.

16. A method for deploying a plurality of seismic devices, comprising:
providing at least a first support craft and a second support craft operating from or above a surface of a body of water; and
deploying at least one cable that is suspended in an arc between the first support craft and the second support craft, the at least one cable having a plurality of seismic devices disposed thereon at predetermined intervals.

17. The method of claim 16, further comprising:
lowering at least a first seismic device to rest on a bottom of the body of water while maintaining suspension in the at least one cable such that the remainder of the plurality of seismic devices are spaced away from the bottom.

18. The method of claim 17, further comprising:
manipulating the at least one cable such that a second seismic device and a third seismic device, the second and third seismic devices being adjacent the first seismic device, come to rest on the bottom at substantially the same time.

19. The method of claim 17, further comprising:
manipulating the at least one cable such that a second seismic device and a third seismic device come to rest on the bottom in a sequential order.

20. The method of claim 16, further comprising:
manipulating the at least one cable to cause each of the plurality of seismic devices to sequentially fall to and rest on a bottom of the body of water at respective predetermined locations on the bottom.

21. The method of claim 20, wherein the manipulating the at least one cable comprises:
manipulating tension of the support cable, length of the support cable, position of the support cable, the locations or distance between the first support craft and the second support craft, and combinations thereof.

22. The method of claim 20, further comprising:
releasing respective ends of the at least one cable into the body of water.

23. A method for deploying a plurality of seismic devices in a water column, comprising:
a) providing at least a first support craft and a second support craft operating from or above a surface of the water column;
b) deploying at least one cable that is suspended in an arc in the water column between the first support craft and the second support craft, the at least one cable having a plurality of seismic devices disposed thereon at predetermined intervals; and
c) manipulating the at least one cable to cause at least one of the plurality of seismic devices to rest at a predetermined location on a bottom of the water column.

24. The method of claim 23, wherein manipulating the at least one cable comprises varying tension of the at least one cable, varying the length of the at least one cable, varying the position of the at least one cable, varying the location or distance between the first support vessel and second support vessel, and combinations thereof.

25. The method of claim 23, wherein one of the plurality of seismic devices rests at the predetermined location prior to the remainder of the plurality of seismic devices.

26. The method of claim 25, wherein the remainder of the plurality of seismic devices rest at a respective predetermined location in a sequential center to end manner.

27. The method of claim 23, wherein the at least one cable comprises a plurality of substantially parallel and spaced apart cables having the plurality of seismic devices disposed in a plurality of rows and columns.

28. The method of claim 27, wherein a substantial central row of seismic devices comes to rest at respective predetermined locations prior to the remainder of the plurality of rows.

29. The method of claim 28, wherein the remainder of the plurality of seismic devices on adjacent rows come to rest at a respective predetermined location in a sequential center to end manner.

30. The method of claim 23, further comprising:
d) releasing respective ends of the at least one cable into the water column.

31. The method of claim 30, further comprising:
e) retrieving the ends of the at least one cable and reattaching each end to the first and second support vessel, respectively.

32. The method of claim 31, further comprising:
f) lifting the at least one cable from the bottom in a substantial arc such that the at least one cable and each of the plurality of seismic devices are suspended in the water column.

33. The method of claim 32, further comprising:
g) moving the at least one cable and the plurality of seismic devices to another location relative to the bottom of the water column.

34. The method of claim 33, further comprising:
h) repeating steps c-d.

35. A system for deploying and positioning ocean bottom equipment, comprising:
at least a first support craft and a second support craft operating from or above a surface of a water column;
at least one cable disposed between the first support craft and the second support craft, the at least one cable having one or more seismic devices disposed thereon at predetermined intervals; and
one or more locational sensors disposed on the one or more seismic devices or the cable.

36. The system of claim 35, wherein the at least one cable comprises a plurality of substantially parallel and spaced apart cables having the one or more seismic devices disposed in a plurality of rows and columns.

37. The system of claim 35, wherein at least one of the first support craft and the second support craft include a transponder that is in communication with the one or more locational sensors.
